(19) United States
(12) Patent Application Publication
(10) Pub. No.: US 2006/0249239 A1
(43) Pub. Date: Nov. 9, 2006

(54) Method for the production of photopolymerizable, cylindrical, continuous seamless flexographic printing elements, and use thereof for the production of cylindrical flexographic printing forms

(76) Inventors: Uwe Krauss, Ludwigshafen (DE); Udo Metzmann, Obrigheim (DE); Jens Schadebrodt, Mainz (DE); Margit Hiller, Karlstadt (DE)

Correspondence Address: CONNOLLY BOVE LODGE & HUTZ, LLP, P O BOX 2207, WILMINGTON, DE, 19899, US

(21) Appl. No.: 10/553,540

(22) PCT Filed: Apr. 14, 2004
(86) PCT No.: PCT/EP04/03955

§ 371 Date: Oct. 17, 2005

(30) Foreign Application Priority Data
Apr. 17, 2003 (DE) 103 18 042.7

(51) Int. Cl. B44C 3/04

(52) U.S. Cl. 156/59

(57) ABSTRACT

Photopolymerizable cylindrical, continuously seamless flexographic printing elements are produced by applying a layer of a photopolymerizable material to the outer surface of a hollow cylinder and joining the edges by calendering. Flexographic printing elements produced in this manner are used for the production of flexographic printing plates.

The present invention relates to a process for the production of photopolymerizable cylindrical, continuously seamless flexographic printing elements by applying a layer of a photopolymerizable material to the outer surface of a hollow cylinder and joining the edges by calendering. The present invention furthermore relates to the use of flexographic printing elements produced in this manner for the production of flexographic printing plates.

Cylindrical flexographic printing plates are known in principle. In the case of a cylindrical flexographic printing plate, the printing cylinder of the printing press is provided over the entire circumference with a printing layer or a printing relief. Cylindrical printing plates are very important for the printing of continuous patterns and are used, for example, for the printing of wallpapers, decorative papers or gift-wrapping papers.

In principle, the actual printing cylinder of the printing press can itself be completely surrounded by a printing layer. However, this procedure has the disadvantage that, on changing the printing plate, it may be necessary to replace the entire printing cylinder. This is extremely complicated and accordingly expensive.

The use of sleeves is therefore usual. Sleeves constitute a cylindrical hollow body which has been provided with a printing layer or a printing relief. Sleeve technology permits very rapid and simple changing of the printing plate. The internal diameter of the sleeves corresponds to the external diameter of the printing cylinder so that the sleeves can be simply pushed over the printing cylinder of the printing press. The pushing on and pushing off of the sleeves functions according to the air cushion principle: for sleeve technology, the printing press is equipped with a special printing cylinder, i.e. an air cylinder. The air cylinder has a compressed air connection to the end face, by means of which compressed air can be passed into the interior of the cylinder. From there, it can emerge again via holes arranged on the outside of the cylinder. For mounting a sleeve, compressed air is passed into the air cylinder and emerges again at the outlet holes. The sleeve can then be pushed onto the air cylinder because it expands slightly under the influence of the air cushion, and the air cushion substantially reduces the friction. When the compressed air feed is terminated, the expansion is eliminated and the sleeve rests firmly on the surface of the air cylinder.

Further details of the sleeve technology are disclosed, for example, in “Technik des Flexodrucks”, page 37 et seq., Coating Verlag, St. Gallen, 1999.

However, high-quality round printing plates cannot be produced by simply completely surrounding the printing cylinder or sleeve with a flexographic printing plate processed ready for printing. In fact, a fine gap which always also cuts through printing parts of the plate in a truly continuous subject remains at the abutting ends of the printing plate. This gap leads to a clearly visible line in the printed image. In order to avoid this line, only nonprinting depressions may be present in this area. It is therefore not possible to print any desired patterns. Moreover, there is in this technology the danger that the solvent contained in the printing ink will penetrate into the gap and may detach the ends of the printing plate from the printing cylinder. This leads to even greater defects in the printed image. Even when the ends are adhesively bonded, clearly visible traces still remain in the printed image.

For the production of high-quality round printing plates, it is therefore necessary to provide the printing cylinder or sleeve by means of suitable techniques with a completely surrounding, relief-forming, photopolymerizable layer. This can be effected, for example, by coating from solution or by ring extrusion. However, both techniques are extremely complicated and therefore correspondingly expensive. A widely used method is therefore to wrap the printing cylinder or the sleeve with a prefabricated, thermoplastically processible layer of photopolymerizable material and to close the abutting edges of the photopolymerizable layer, also referred to as the seam, as well as possible by means of suitable techniques. Only in a second step is the cylindrical photopolymerizable flexographic printing element processed to give the final round printing plate. Apparatuses for the processing of cylindrical flexographic printing elements are commercially available.

In the production of photopolymerizable flexographic printing elements using prefabricated layers, it is particularly important to close the seam completely and with extreme precision. The importance of this process step has further increased in recent years. Modern photopolymerizable flexographic printing elements, for example digitally imagable flexographic printing elements, permit the production of flexographic printing plates having substantially higher resolution than was previously the case. Flexographic printing is therefore also increasingly being used in those areas which were previously the preserve of other printing methods. At relatively high resolution, however, defects in the printing surface of the flexographic printing plate are also more quickly visible. For the same reason, high precision must also be ensured when applying the photopolymerizable, relief-forming layer. Thickness differences in the relief-forming layer have a considerable adverse effect on the truth of running of the printing cylinder and hence the print quality. In the case of a high-quality flexographic printing plate, the thickness tolerance should usually be not more than ±10 μm.

If the thickness tolerance of the photopolymerizable layer of the sleeve is insufficient, the surface of the sleeve must be reworked. DE-A 31 25 564 and EP-A 469 375 disclose processes for improving the print quality, in which the surface of the cylindrical flexographic printing element is first ground and then smoothed with a suitable solvent and remaining irregularities are, if necessary, filled with binder or with the material of the photosensitive layer. Such a procedure is of course extremely complicated, tedious and expensive.

Photopolymerizable, cylindrical flexographic printing elements can be produced, for example, by applying a layer of photopolymerizable material to a sleeve so that the cut edges abut one another and then heating to about 160° C. until the material begins to melt and the cut edges run into one another.

DE-A 29 11 980 discloses a process in which a printing cylinder is wrapped with a photosensitive resin film without there being a substantial distance or a substantial overlap between the plate ends. The seam is closed by bringing the printing cylinder into contact with a rotating calendar roll and joining the cut edges to one another by melting.

During the melting of the photopolymerizable layer, however, it is scarcely possible to prevent the thickness of the photosensitive layer from changing in an irregular manner. The printing cylinders or sleeves produced with the aid of such melting processes must therefore be reground and smoothed in order to obtain a good surface and to ensure printing of high quality. EP-A 469 375 already points this out. Moreover, readily volatile components of the layer, e.g. monomers, may evaporate during the melting of the layer, with the result that the properties of the layer change in a disadvantageous manner.

DE 27 22 896 has proposed adhesively bonding a commercial, sheet-like photopolymerizable flexographic printing element, together with the substrate film, to a printing cylinder or sleeve so that the cut edges abut one another. The cut edges are straight and are then welded to one another under pressure and heat. The welding can also be effected with the aid of a heated calendar roll by rotating the printing cylinder under pressure in contact with the calender roll until the ends join to one another. The use of a plate having a substrate film is, however, extremely problematic. Typical substrate films have a thickness of from 0.1 to 0.25 mm. If the substrate film does not completely cover the circumference and also leaves only a minimum gap between the ends owing to a small mounting or trimming error, the empty space present between the film ends fills with polymeric material during calendering, and an impression of this gap remains on the surface of the photopolymerizable layer and leads to visible defects in the print. Such a flexographic printing element, too, must therefore generally be reground and smoothed.

Another technique has been proposed by U.S. Pat. No. 6,326,124, namely closing an existing gap with a gap-sealing compound comprising binder, UV absorber and solvent. The gap-sealing compound is, however, not identical to the photopolymeric mixture, so that the closed gap has properties differing from those of the remaining relief layer, inter alia different ink acceptance behavior. The gap is therefore still detectable in the printed image, and the printing plate is not a truly continuously seamless printing plate.

U.S. Pat. No. 5,916,403 proposes an apparatus of complicated design, by means of which a sleeve can be coated with molten photopolymer material and the layer can be calendered. It is also possible to use plate-like polymer material in molten or solid form for coating the sleeve. If a plate-like material is used, either a gap is left between the ends, which has to be closed by calendering at elevated temperatures, or the ends overlap and the excess part likewise has to be smoothed by calendering.

In addition to the problem of high-quality seam closure and the obtaining of a layer thickness as constant as possible, preexposure from the back represents a further problem of the sleeve technology. Before the actual main exposure, flexographic printing elements are usually preexposed from the back through the substrate film for a short time. As a result of this, the relief base is prepolymerized and a better shoulder shape, in particular of fine relief elements, in the relief base is achieved.

In the case of sleeves, preexposure from the back is not usually possible since the conventional sleeve materials, for example glass fiber-reinforced plastic or metal, are not transparent to UV radiation. EP-A 766 142 has proposed the use of transparent sleeves, in particular sleeves of polyesters, such as PET or PEN, in a thickness of from 0.25 mm to 5 cm. However, these are expensive. Furthermore, special exposure units are required for uniform exposure of the sleeve from the inside. In addition, in the case of transparent sleeves, a person skilled in the art is faced with a typical dilemma. The mechanical stability of the sleeve increases with increasing thickness of the sleeve, whereas the transparency of the sleeve to actinic light decreases with increasing thickness of the sleeve. The problem of efficient exposure of sleeves from the back without a reduction in the stability of the sleeve remains unsolved.

It is in principle possible to preexpose a solid photopolymerizable layer from the back even before application to the sleeve. However, it has not been possible to date for sleeves preexposed in this manner to be welded as satisfactorily as would be expedient and necessary for producing high-quality continuously seamless printing plates, because, as is known, only the uncrosslinked, but not the exposed, crosslinked, polymer layer can be satisfactorily welded. Furthermore, the effect of the preexposure is frequently lost again through the welding of the layer ends at elevated temperatures. This leads to fine relief dots in particular having a poor shoulder shape.

In solving this problem, DE-A 37 04 694 has therefore proposed first applying a first layer of photopolymer material to a sleeve, welding the seam and then polymerizing the photopolymeric layer from the front by exposure to light. In a second process step, a photopolymeric layer is applied to the first, crosslinked layer and its seam too is welded. This two-stage process is, however, very inconvenient and expensive.

It is an object of the present invention to provide an improved process for the production of cylindrical, continuously seamless, photopolymerizable flexographic printing elements which ensures better closure of the seam than in the case of the known technologies and very good truth of running. Preexposure from the back should be possible in a simple manner without adversely affecting satisfactory closure of the seam. Furthermore, reworking of the flexographic printing element by grinding and smoothing should be avoided, and the process should be capable of being carried out as rapidly as possible. In addition, reuse of the used sleeve should be possible without great effort.

We have found that this object is achieved by a process for the production of photopolymerizable cylindrical, continuously seamless flexographic printing elements by applying a layer of a photopolymerizable material, comprising at least one elastomeric binder, ethylenically unsaturated monomers and a photoinitiator, to the outer surface of a hollow cylinder and joining the ends of the layer by calendering, wherein the process comprises the following steps:
(a) providing a laminate at least comprising a layer of a photopolymerizable material and a substrate film which can be peeled off from the layer,
(b) cutting to size those edges of the laminate which are to be joined, by means of miter cuts,
(c) pushing and locking the hollow cylinder onto a rotatably mounted support cylinder,
(d) applying an adhesion-promoting layer to the outer surface of the hollow cylinder,
(e) applying the laminate cut to size, on the side facing away from the temporary substrate film, to the hollow cylinder provided with the adhesion-promoting layer, the ends provided with the miter cut lying substantially one on the other, but not overlapping,
(f) peeling off the substrate film from the layer of photopolymerizable material,
(g) joining the cut edges at a temperature below the melting point of the photopolymerizable layer by bringing the surface of the photopolymerizable layer on the hollow cylinder into contact with a rotating calender roll until the cut edges have been joined to one another,
(h) removing the processed hollow cylinder from the support cylinder.

In a preferred embodiment of the invention, the adhesion-promoting layer is a double-sided adhesive tape.

We have furthermore found cylindrical continuously seamless photopolymerizable flexographic printing elements which are obtainable by the process described, and the use thereof for the production of flexographic printing plates by means of laser engraving or digital imaging.

We have moreover found an apparatus particularly suitable for carrying out the process.

By means of the novel process, it is possible, in a surprisingly simple manner, to obtain cylindrical, continuously seamless photopolymerizable flexographic printing elements of high quality. Very good seam closure is achieved. Reworking of the resulting flexographic printing element by complicated grinding and smoothing processes is superfluous. Preexposure of the flexographic printing element from the back is possible even without it being necessary to use a transparent sleeve. It was also surprising and unexpected for a person skilled in the art that, in spite of the preexposure from the back, stable and high-quality seam closure is still possible by means of the novel process. Ready-to-use flexographic printing elements can be produced within not more than 1 hour from the starting materials by means of the novel process.

### LIST OF FIGURES

FIG. 1: Cross section through a flexographic printing element prepared for calendering, in which the edges to be joined have been cut to size by means of a miter cut and laid one on top of the other (schematic).

FIG. 2: Cross section through the preferred apparatus for carrying out the novel process (schematic).

Regarding the present invention, the following may be stated specifically:

For carrying out the novel process, a laminate which comprises at least one layer of the photopolymerizable material and a substrate film which can be peeled off from the layer is first provided in step (a). The laminate can optionally also comprise a further peelable film on that side of the layer which faces away from the substrate film. For better peelability, both the substrate film and the second film can be treated in a suitable manner, for example by siliconization or by coating with a suitable nontacky release layer. Such nontacky release layers may consist, for example, of polyamides or polyvinyl alcohols.

The photopolymerizable material is a conventional photopolymerizable material which is typical for use in flexographic printing elements and comprises at least one elastomeric binder, ethylenically unsaturated monomers and a photoinitiator or a photoinitiator system. Such mixtures are disclosed, for example, in EP-A 084 851.

The elastomeric binder may be a single binder or a mixture of different binders. Examples of suitable binders are the known vinylaromatic/diene copolymers or block copolymers, such as conventional block copolymers of the styrene/butadiene or styrene/isoprene type, and furthermore diene/acrylonitrile copolymers, ethylene/propylene/diene copolymers or diene/acrylate/acrylic acid copolymers. Of course, mixtures of different binders may also be used.

The binders or binder mixtures used for the novel process are preferably those which have very little tack. Thermoplastic elastomeric binders of the styrene/butadiene type have proven particularly useful for the novel process. These may be two-block copolymers, three-block copolymers or multiblock copolymers in which in each case a plurality of styrene and butadiene blocks follow one another alternately. They may be linear, branched or star block copolymers. The block copolymers used according to the invention are preferably styrene/butadiene/styrene three-block copolymers, it being necessary to take into account the fact that commercial three-block copolymers usually comprise a certain proportion of two-block copolymers. Such SBS block copolymers are commercially available, for example under the name Kraton®. Of course, mixtures of different SBS block copolymers may also be used. A person skilled in the art makes a suitable choice from the various types depending on the desired properties of the layer.

Styrene/butadiene block copolymers which have an average molecular weight M_{W} (weight average) of from 100 000 to 250 000 g/mol are preferably used. The preferred styrene content of such styrene/butadiene block copolymers is from 20 to 40% by weight, based on the binder.

The ethylenically unsaturated monomers are in particular acrylates or methacrylates of mono- or polyfunctional alcohols, acrylamides or methacrylamides, vinyl ethers or vinyl esters. Examples include butyl (meth)acrylate, 2-ethylhexyl (meth)acrylate, butanediol di(meth)acrylate and hexanediol di(meth)acrylate. Mixtures of different monomers can of course also be used. Suitable initiators for the photopolymerization are aromatic compounds, for example keto compounds, such as benzoin or benzoin derivatives.

The photopolymerizable mixtures may furthermore comprise conventional assistants, for example thermal polymerization inhibitors, plasticizers, dyes, pigments, photochromic additives, antioxidants, antiozonants or extrusion assistants.

The type and amount of the components of the photopolymerizable layer are determined by a person skilled in the art according to the desired properties and the desired purpose of the novel flexographic printing element.

If the flexographic printing element is to be processed by means of direct laser engraving to give a flexographic printing plate, the person skilled in the art can also choose formulations for the layer which are particularly adapted to direct laser engraving. Such formulations are disclosed, for example, by WO 02/76739, WO 02/83418, WO 03/45693 or the still unpublished documents having the application numbers DE 102 27 188.7 and DE 102 27 189.5, which are hereby incorporated by reference.

The laminates can be produced in a manner known in principle, by dissolving all components of the photopolymerizable layer in a suitable solvent, casting the solution on the peelable substrate film and allowing the solvent to evaporate. Preferably, the laminate is produced, likewise in a manner known in principle, by melt extrusion and calendering between the peelable substrate film and a further peelable film. Such photopolymerizable laminates are also commercially available, for example as nyloflex® SL (BASF Drucksysteme GmbH). Laminates which have two or more photopolymerizable layers can also be used. The thickness of the laminate is as a rule from 0.4 to 7 mm, preferably from 0.5 to 4 mm, particularly preferably from 0.7 to 2.5 mm.

The photopolymerizable layer can optionally be preexposed to actinic light from the back before application to the hollow cylinder in process step (e). The preexposure is carried out on that side of the photopolymerizable layer which faces away from the substrate film, i.e. the subsequent underside of the layer. During the preexposure, the surface of the photopolymerizable layer can be directly irradiated. If a second peelable film is present, this second film can either be peeled off or exposure is preferably effected through the film, provided that the film is sufficiently transparent.

The preexposure is carried out similarly to the conventional preexposure of flexographic printing plates from the back. The preexposure time is as a rule from only a few seconds to not more than one minute and is established by a person skilled in the art according to the desired properties of the layer. Of course, the preexposure time also depends on the intensity of the actinic light. Only the layer base is polymerized and on no account is the entire layer completely polymerized.

Depending on the desired purpose of the flexographic printing element, a person skilled in the art determines whether a preexposure step is carried out or not. If the further processing of the flexographic printing element to give flexographic printing plates is intended to be effected by a conventional method by imagewise exposure and development by means of a solvent, a preexposure is as a rule advisable, although not always absolutely essential. If further processing by means of direct laser engraving is intended, a preexposure step is as a rule superfluous.

The preexposure should as a rule be carried out before the laminate is cut to size in step (b), in order to ensure trouble-free joining of the cut edges. If a transparent sleeve is used, the preexposure can of course also be carried out from the inside of the sleeve just after application of the layer to the sleeve.

In process step (b), the edges of the prepared laminate to be joined are cut to size. According to the invention, the cutting to size is carried out by means of miter cuts, i.e. by means of cuts which are made not perpendicularly through the laminate but obliquely. The length of the laminate is determined by the cuts so that the circumference of the sleeve can be completely surrounded and the ends provided with the miter cuts lie substantially one on top of the other but do not overlap.

As a rule, the miter angle is from 10° to 80°, preferably from 20° to 70°, particularly preferably from 30° to 60°, for example 50°. Said angles are relative in each case to the perpendicular through the layer. Both cut edges can be cut with the same miter angle. Relatively small deviations with the miter angle of the two cut edges from one another are, however, also possible without the proper joining of the cut edges being adversely affected. Rather, the fact that the internal diameter of the photopolymerizable layer is slightly smaller than the external diameter can be taken into account in a particularly elegant manner by slightly different miter angles. The miter angles are calculated so that, after cutting, the subsequent inside of the photopolymerizable layer is exactly the correct amount shorter than the subsequent outside. However, the angles should as a rule deviate from one another by not more than about 20°, preferably not more than 10°.

Of course, the lateral edges can also be cut to size if the width of the raw material does not fit. The lateral edges are preferably cut straight. The width of the laminate cannot of course exceed the maximum sleeve length. As a rule, the entire length of the sleeve is not covered with the photopolymeric material, but in each case a narrow strip is left uncovered at the ends. This is determined by a person skilled in the art according to the desired properties of the flexographic printing element.

The hollow cylinders used as supports are conventional hollow cylinders which are suitable for mounting on air cylinders, i.e. are capable of expanding slightly under the influence of compressed air. Such hollow cylinders are also referred to as sleeves, basic sleeves or the like. For the purposes of this invention, the hollow cylinders as such which are used as supports are to be referred to below as basic sleeve while the term sleeve is to be reserved for the flexographic printing element as a whole, i.e. including the photopolymerizable layer, adhesive layer and any further layers.

Basic sleeves of polymeric materials, for example polyurethanes, polyesters or polyamides, are particularly suitable for carrying out the novel process. The polymeric materials may also be reinforced, for example with glass fiber fabrics. They may also be multilayer materials. Furthermore, basic sleeves comprising metals, for example those comprising nickel, may of course be used.

The thickness, diameter and length of the basic sleeve are determined by a person skilled in the art according to the desired properties and the desired purpose. By varying the wall thickness at constant internal diameter (necessary for mounting on certain printing cylinders), the outer circumference of the basic sleeve and hence the printing length can be determined. By printing length, a person skilled in the art understands the length of the printed subject on one revolution of the printing cylinder. Suitable basic sleeves having wall thicknesses of from 1 to 100 mm are commercially available, for example as Blue Light from Rotec or from Polywest or Rossini. They may be both compressible basic sleeves and hard-coated basic sleeves.

For carrying out the novel process, the hollow cylinders used are pushed and locked onto a rotatably mounted support cylinder in process step (c) so that the hollow cylinder is firmly connected to the support cylinder and no movement relative to one another is possible. The support cylinder provides firm retention for the subsequent calendering process. The locking can be effected, for example, by clamping or screwing. However, the support cylinder is preferably an air cylinder whose mode of operation corresponds to the air cylinders used in printing presses. The basic sleeve is then mounted in a very elegant manner by connecting the air cylinder to compressed air for pushing on and hence enabling the basic sleeve to be pushed on. After the compressed air has been switched off, the basic sleeve is firmly locked on the air cylinder. The circumference of the air cylinder can also be increased in a manner known in principle by using adapter or bridge sleeves (actually basic sleeves). It is thus possible to use basic sleeves having a larger internal diameter, and greater printing lengths are thus also achievable with the same air cylinder. Adapter sleeves are also commercially available (for example from Rotec).

In process step (d), an adhesion-promoting layer is applied to the outer surface of the hollow cylinder. The adhesion-promoting layer should impart good adhesion even at elevated temperatures such as those which will prevail during the calendering process. It should in particular impart very good shear strength so that the photopolymerizable layer does not slip on the surface of the hollow cylinder during the calendering process. The adhesion-promoting layer may be a suitable mixture of adhesive-forming components which is applied to the surface of the hollow cylinder.

Preferably, however, the adhesion-promoting layer is a double-sided adhesive film. Double-sided adhesive films for mounting printing plates are known and are available in various embodiments. In particular, the adhesive films may be foam-backed adhesive films which additionally have a damping foam layer.

The adhesive film should have a very high static shear strength. The static shear strength is determined on the basis of DIN EN 1943. In this test, a piece of the adhesive film having exactly defined dimensions is stuck onto a polished metal plate and pulled horizontally thereon with an exactly defined force. The time taken for the tape to move 2.5 mm on the substrate is measured. The test can be carried out at elevated temperatures. The details of the test are listed in the example section.

An adhesive film which has a static shear strength of at least 3, preferably at least 10, particularly preferably at least 100, hours at 70° C. is preferably used for carrying out the present invention.

If a foam-backed adhesive tape is used, an adhesive tape whose foam layer consists of an open-cell foam, for example an open-cell PU foam, is preferably used. As a rule, a smoother surface of the photopolymerizable layer than with the use of closed-cell foams is achieved therewith at the point at which the ends of the adhesive tape abut.

The double-sided adhesive tape should be stuck onto the surface of the hollow cylinder in such a way that the cut edges exactly abut one another and substantially neither does a space remain between the ends nor do the ends overlap.

In process step (e), the photopolymerizable layer is applied to the hollow cylinder provided with the adhesion-promoting layer. For this purpose, the laminate cut to size is applied, on the side facing away from the temporary substrate film, to the hollow cylinder provided with the adhesion-promoting layer. If a second peelable film is present, this, including any nontacky release layer present, must of course be removed before the application. The application should be effected without bubbles and is carried out in such a way that the ends provided with the miter cut lie substantially one on top of the other but do not overlap.

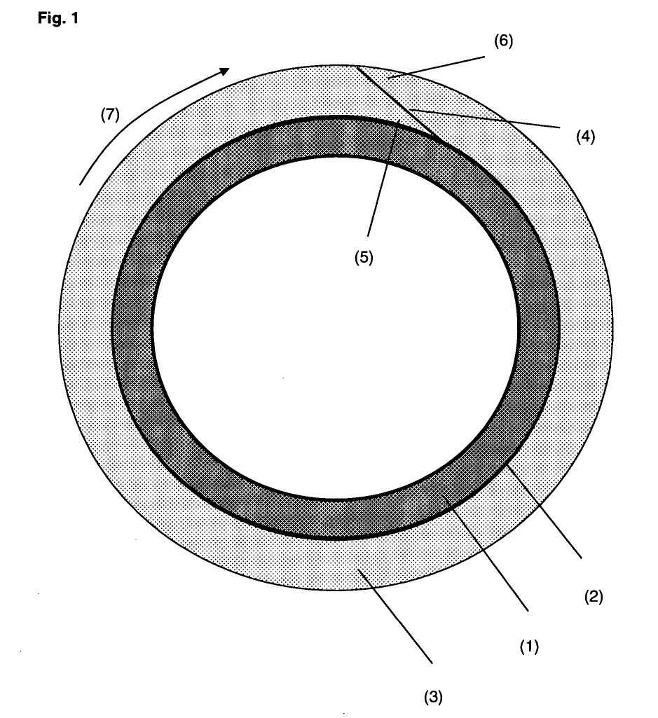

FIG. 1 schematically shows a cross section through a flexographic printing element which has been prepared for calendering and in which the edges to be joined have each been cut to size by means of a miter cut and placed one on top of the other: an adhesive tape (2) and the photopolymerizable layer (3) are applied to the basic sleeve (1). The edges to be joined are cut to size by means of miter cuts (4) and placed one on top of the other. The arrow (7) indicates the preferred direction of rotation of the flexographic printing element during calendering. The air cylinder has been omitted in FIG. 1 for greater clarity.

In order to ensure that the cut edges lie properly one on top of the other, the application of the layer element is expediently therefore begun with the cut edge whose bottom is longer than the top (FIG. 1, (5)). After complete wrapping, the second cut edge (6), at which the top is longer than the bottom, finally lies on the first cut edge.

After the application of the layer element, the substrate film, including any nontacky release layer present, is peeled off from the layer of photopolymeric material (process step (f)).

In process step (g), the cut edges are joined. For joining the cut edges, the surface of the photopolymerizable layer on the hollow cylinder is brought into contact with a rotating calender roll until the cut edges have been joined to one another. The support cylinder and the calender roll rotate in opposite directions. The necessary calender pressure is determined by a person skilled in the art according to the type of photopolymerizable layer by adjusting the distance between the support cylinder and the calender roll. The calendering temperature depends on the type of photopolymerizable layer and the desired properties. According to the invention, however, the temperature of the calender roll is adjusted so that the temperature of the photopolymerizable layer is in any case below its melting point, so that the adverse effects mentioned at the outset and due to melting of the layer are avoided.

Expediently, heat is supplied by using a calender roll heated from the inside. However, heat can also be supplied, for example, by IR lamps or warm gas streams. Of course, heat sources can also be combined. As a rule, the temperature during calendering is from 80 to 130° C., preferably from 90 to 120° C., measured in each case at the surface of the photopolymerizable layer.

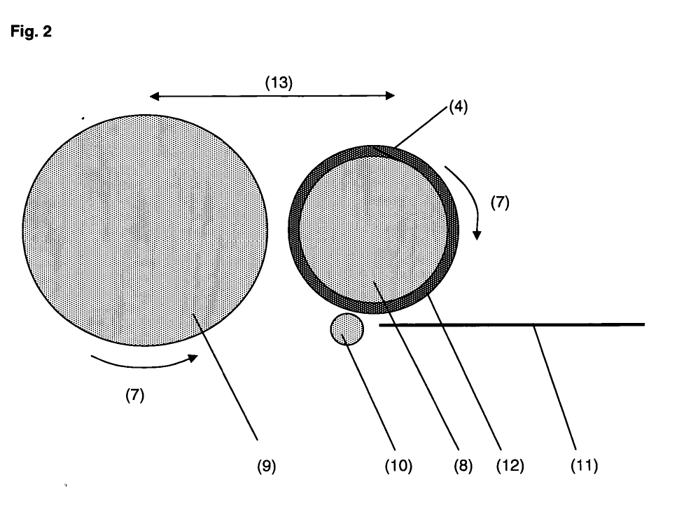

The calendering is particularly preferably carried out in such a way that the coated hollow cylinder rotates in the direction (7) during calendering. The preferred direction of rotation is indicated in FIG. 1 and FIG. 2 by the arrow (7) and can be achieved by appropriate adjustment of the direction of rotation of the rolls. Since the calender roll and the coated hollow cylinder rotate in opposite directions during calendering (FIG. 2), the upper cut edge (6) is calendered in the direction of decreasing layer thickness in the case of this direction of rotation. Consequently, opening of the gap is advantageously avoided although it is also possible in special cases to calender in the opposite direction. As a rule, about 15 minutes are required for complete closure of the gap, this time of course also depending on the chosen temperature and the pressure.

As a result of the calendering, the cut edges are firmly joined to one another. Joining is effected mainly in the region of the photopolymeric layer which was not preexposed. In the lower layer region which was preexposed, the edges do not join or at least do not join so well. This of course also depends on the intensity of the preexposure and hence on the degree of the preliminary crosslinking. By means of the novel process, however, it is surprisingly nevertheless possible to achieve very good, durable joining of the edges.

After the closure of the seam and any cooling, the processed hollow cylinder/prepared sleeve is removed again from the support cylinder.

The apparatus shown schematically in FIG. 2 has proven very particularly useful for carrying out the process, without the invention being limited thereby to the use of this apparatus.

The apparatus has an air cylinder (8) and a heatable calender roll (9). Both cylinders are rotatably mounted. The suspensions of the cylinders are not shown for the sake of clarity. At least one of the two rolls is moreover mounted so as to be displaceable in the horizontal direction so that the rolls can be moved together and apart. This is indicated schematically by the double-headed arrow (13). For heating, for example, electrical heating elements can be installed in the calender roll or hot oil can flow through the roll. An auxiliary roll (1) whose distance from the air cylinder can be adjusted is also provided as an aid for mounting. The auxiliary roll (10) is preferably arranged below the air cylinder. The auxiliary roll is preferably a rubber roll. The apparatus furthermore has a feed apparatus (11) for the photopolymerizable layer and/or the adhesive film. The feed apparatus may simply be, for example, an assembly table on which the photopolymerizable layer and/or the adhesive film can be placed and can be inserted from there uniformly into the gap between basic sleeve and auxiliary roll. This can be effected manually, preferably by means of a suitable pushing apparatus. The calender roll should have very little adhesion to the photopolymerizable layer. For example, it may be polished or may have a coating for eliminating tack, for example a Teflon coating. The apparatus can of course also comprise further assemblies.

The operation of the apparatus is explained by way of example below without there being any intention thereby to limit the invention to this mode of operation or at all to the use of the apparatus. For carrying out the process, a basic sleeve (12) is first pushed onto the air cylinder (8). Thereafter, the adhesive film is cut to size on the assembly table (11), the air cylinder is rotated and the film is slowly pushed into the gap between auxiliary roll (10) and the air cylinder (8) provided with the basic sleeve (12). The adhesive film is carried along as a result of the rotation, the auxiliary roll pressing the film onto the basic sleeve so that the adhesive film firmly adheres to the basic sleeve without bubbles. The protective film is then peeled off from the adhesive film. The basic sleeve is then provided with an adhesion-promoting layer. In the next step, the photopolymerizable laminate cut to size is pushed into the gap, carried along and pressed firmly by the auxiliary roll (10). The unpreexposed or preexposed underside of the layer faces the basic sleeve. If the photopolymerizable layer has a second, peelable film, this is peeled off beforehand. After the substrate film of the laminate has been peeled off, the calender roll and the air cylinder provided with basic sleeve, adhesion-promoting layer and photopolymerizable layer are brought into contact with one another, caused to rotate, and the gap is closed by calendering with the hot calender roll. The preferred direction of rotation during calendering is (7).

The process steps (a) to (h) can be carried out in this sequence. However, variations are also possible. Thus, it is entirely possible first to apply the adhesion-promoting layer (step (c)) and the photopolymerizable layer (step (e)) to the basic sleeve and only thereafter to push the coated basic sleeve onto the support cylinder (c).

The cylindrical, continuously seamless flexographic printing elements obtainable by the novel process differ from those known from the prior art. Traces of the miter cut are still detectable as a discontinuity in the region of the closed seam by means of suitable analytical methods (for example microscopic observation, if necessary by means of polarized light). If preexposure was effected, the seam is clearly detectable in the lower layer region. Nevertheless, a printing layer completely uniform with regard to the printing properties is obtained, so that a visible seam is no longer present in the printed image. Stress-strain measurements using layer samples from the region of the closed seam and those without a seam have comparable values.

In the novel process, no monomers at all evaporate during calendering, owing to the comparatively low temperature. Furthermore, the effect of the preexposure from the back is also retained. Both contribute toward a constant high layer quality, a requirement for high-quality printing plates.

The novel flexographic printing elements are very useful as a starting material for the production of cylindrical, continuously seamless flexographic printing plates.

The further processing to give flexographic printing plates can be carried out by various techniques. The flexographic printing elements can, for example, be exposed imagewise in a manner known in principle and the unexposed parts of the relief-forming layer then removed by means of a suitable development process. The imagewise exposure can be carried out in principle by surrounding the sleeve with a photographic mask and effecting exposure through the mask.

Preferably, however, the imaging is carried out by means of digital masks. Such masks are also known as in situ masks. For this purpose, a digitally imagable layer is first applied to the photopolymerizable layer of the sleeve.

The digitally imagable layer is preferably a layer selected from the group consisting of IR-ablative layers, inkjet layers and thermographically inscribable layers.

IR-ablative layers or masks are opaque to the wavelength of actinic light and usually comprise a binder and at least one IR absorber, for example carbon black. Carbon black also ensures that the layer is opaque. In the IR-ablative layer, a mask can be inscribed by means of an IR laser, i.e. the layer is decomposed and material removed in the areas in which the laser beam is incident on said layer. Examples of the imaging of flexographic printing elements using IR-ablative masks are disclosed, for example, in EP-A 654 150 or EP-A 1 069 475.

In the case of inkjet layers, a layer inscribable using inkjet inks and transparent to actinic light, for example a gelatin layer, is applied. A mask is applied to said gelatin layer using opaque ink by means of inkjet printers. Examples are disclosed in EP-A 1 072 953.

Thermographic layers are layers which contain substances which become black under the influence of heat. Such layers comprise, for example, a binder and an organic silver salt and can be imaged by means of a printer having a thermal printing head. Examples are disclosed in EP-A 1 070 989.

The digitally imagable layers can be produced by dissolving or dispersing all components of the respective layer in a suitable solvent and applying the solution to the photopolymerizable layer of the cylindrical flexographic printing element, followed by evaporation of the solvent. The application of the digitally imagable layer can be effected, for example, by spraying on or by means of the technique described by EP-A 1 158 365. Components soluble in water or predominantly aqueous solvent mixtures are preferably used for the production of the digitally imagable layer.

After the application of the digitally imagable layer, the latter is imaged by means of the respective suitable technique and then the sleeve is exposed to actinic light through the mask formed in a manner known in principle. In particular, UVA or UV/VIS radiation is known to be suitable as actinic, i.e. chemically active, light. Rotary, cylindrical exposure units for uniform exposure of sleeves are commercially available.

The development of the imagewise exposed layer can be carried out in a conventional manner by means of a solvent or of a solvent mixture. The unexposed parts of the relief layer, i.e. those parts covered by the mask, are removed by dissolution in the developer, while the exposed, i.e. the crosslinked, parts are retained. The mask or the remainder of the mask is likewise removed by the developer if the components are soluble therein. If the mask is not soluble in the developer, it is, if required, removed with the aid of a second solvent before development.

The development can also be effected thermally. In the thermal development, no solvent is used. Instead, the relief-forming layer is brought into contact with an absorbing material after the imagewise exposure and is heated. The absorbing material is, for example, a porous nonwoven, for example comprising nylon, polyester, cellulose or inorganic materials. It is heated to a temperature such that the unpolymerized parts of the relief-forming layer liquefy and can be absorbed by the nonwoven. The saturated nonwoven is then removed. Details of the thermal development are disclosed, for example, by U.S. Pat. No. 3,264,103, U.S. Pat. No. 5,175,072, WO 96/14603 or WO 01/88615. The mask can, if necessary, be removed beforehand by means of a suitable solvent or likewise thermally.

The production of cylindrical flexographic printing plates from the photopolymerizable, continuously seamless flexographic printing elements can also be carried out by means of direct laser engraving.

In this process, the photopolymerizable layer is first completely crosslinked in the total volume by means of actinic light without placing a mask on top. A printing relief is then engraved into the crosslinked layer by means of one or more lasers.

The uniform crosslinking can be effected using conventional rotary, cylindrical exposure units for sleeves, as described above. However, it can also particularly advantageously be effected on the basis of the method described in WO 01/39897. Here, exposure is effected in the presence of an inert gas which is heavier than air, for example CO₂ or Ar. For this purpose, the photopolymerizable, cylindrical flexographic printing element is lowered into an immersion tank which is filled with inert gas and whose walls are preferably lined with a reflective material, for example aluminum foil. The lowering is preferably effected in such a way that the axis of rotation of the cylindrical flexographic printing element is vertical. The immersion tank can be filled with inert gas, for example, by introducing dry ice into the immersion tank, which displaces the atmospheric oxygen on vaporization. Exposure is then effected from above by means of actinic light. In principle, the conventional UV or UVNIS sources of actinic light can be used for this purpose. Radiation sources which emit substantially visible light and no UV light or only small amounts of UV light are preferably used. Light sources which emit light having a wavelength of more than 300 nm are preferred. For example, conventional halogen lamps can be used. The process has the advantage that the ozone pollution usual in the case of short-wave UV lamps is virtually completely absent, safety measures to prevent strong UV radiation are as a rule unnecessary and no expensive apparatuses are required. Thus, this process step can be carried out particularly economically.

In direct laser engraving, the relief layer absorbs laser radiation to such an extent that said layer is removed or at least detached in those parts in which it is exposed to a laser beam of sufficient intensity. Preferably, the layer will vaporize or thermally or oxidatively decompose before melting, so that its decomposition products are removed from the layer in the form of hot gases, vapors, fumes or small particles.

Lasers which have a wavelength of from 9 000 to 12 000 nm are particularly suitable for engraving the relief-forming layers used according to the invention. Particular examples of these are CO₂ lasers. The binders used in the relief-forming layer absorb the radiation of such lasers to a sufficient extent to permit engraving.

A laser system which has only a single laser beam can be used for engraving. Preferably, however, laser systems which have two or more laser beams are used. Preferably, at least one of the beams is specially adapted for producing coarse structures and at least one of the beams is specially adapted for writing fine structures. With such systems, it is possible to produce high-quality printing plates in a particularly elegant manner. For example, the beam for producing the fine structures may have a lower power than the beams for producing coarse structures. For example, the combination of a beam having a power of from 50 to 150 W with two beams of 200 W or more each has proven particularly advantageous. Multibeam laser systems particularly suitable for laser engraving and suitable engraving methods are known in principle and are disclosed, for example, in EP-A 1 262 315 and EP-A 1 262 316.

The depth of the elements to be engraved depends on the total thickness of the relief and on the type of elements to be engraved and is determined by a person skilled in the art according to the desired properties of the printing plate. The depth of the relief elements to be engraved is at least 0.03 mm, preferably 0.05 mm—the minimum depth between individual dots is mentioned here. Printing plates having relief depths which are too small are generally unsuitable for printing by means of the flexographic printing technique because the negative elements fill with printing ink. Individual negative dots should usually have greater depths; for those of 0.2 mm diameter, a depth of at least from 0.07 to 0.08 mm is usually advisable. In the case of surfaces which have been removed by engraving, a depth of more than 0.15 mm, preferably more than 0.4 mm, is advisable. The latter is of course possible only in the case of a correspondingly thick relief.

The cylindrical flexographic printing plate obtained can advantageously be subsequently cleaned in a further process step after the laser engraving. In some cases, this can be effected by simply blowing off with compressed air or brushing off. It is however preferable to use a liquid cleaning agent for the subsequent cleaning in order also to be able to remove polymer fragments completely.

For example, aqueous cleaning agents which substantially comprise water and optionally small amounts of alcohols, and which may contain assistants, such as surfactants, emulsifiers, dispersants or bases, for supporting the cleaning process, are suitable. Water-in-oil emulsions, as disclosed by EP-A 463 016, are also suitable.

The cylindrical printing plates obtained by means of digital imaging or by means of direct laser engraving are very useful for the printing of continuous patterns. They may have any desired printing areas even in the region of the seam without the seam also being visible in the printed image. If adhesive tape was used as the adhesion-promoting layer, the printing layer can be very easily peeled off from the basic sleeve again and reused. In this case, it is possible to use basic sleeves of different types, for example compressible basic sleeves or hard-coated basic sleeves.

The examples which follow illustrate the invention:

Methods of Measurement:

Determination of static shear strength of the adhesive film on the basis of DIN EN 1943, Klebebänder—Messung des Scherwiderstandes unter statischer Belastung (January 2003 edition).

Testing was carried out according to method A described. For the test, a steel plate specified in DIN EN1943 was used. The steel plate was clamped perpendicularly in a holding apparatus. A 25 mm wide test strip of the adhesive film was stuck onto said steel plate so that the area of contact with the steel plate was exactly 25 mm×25 mm and a part of the adhesive tape hung perpendicularly below the steel plate. The test mass of 1 kg was suspended from the freely hanging end of the adhesive tape. The test was carried out at 70° C. The time taken for the adhesive tape to slip 2.5 mm downward on the steel plate was determined.

Provision of the Laminate:

Layer Element 1:

The following starting materials were used for the photopolymerizable, elastomeric layer:

| Component | Amount |
|---|---|
| SBS block copolymer (M_{w} 125 000 | 55% |
| g/mol, styrene content 30% by | |
| weight (Kraton D 1102)) | |
| Polybutadiene oil plasticizer | 32% |
| Hexanediol diacrylate monomer | 10% |
| Photoinitiator | 2% |
| Additives (heat stabilizer, dye) | 1% |
| Total | 100% |

The layer element used as starting material for the novel process was produced from the components in a manner known in principle by melt extrusion and calendering between two peelable PET films provided with a nontacky release layer (substrate film and second film). The photopolymerizable layer had a thickness of 1.14 mm.

Layer Element 2:

A layer element of the same type as described in the case of layer element 1 was produced, except that the following starting materials were used for the photopolymerizable layer.

| Component | Amount |
|---|---|
| SBS block copolymer (M_{w} 125 000 | 58% |
| g/mol, styrene content 30% by | |
| weight, extended with about 33% | |
| of oil (Kraton D 4150)) | |
| Secondary binder SB two-block | 10% |
| copolymer, M_{w} 230 000 g/mol | |
| (Kraton DX 1000) | |
| Polybutadiene oil plasticizer | 23% |
| Hexanediol diacrylate monomer | 7% |
| Photoinitiator | 1% |
| Additives (heat stabilizer, dyes) | 1% |
| Total | 100% |

Production of the Cylindrical, Continuously Seamless Flexographic Printing Elements:

### EXAMPLE 1

An apparatus of the type described above was used for the procedure. The auxiliary roll (1) was rubber-coated. The calender roll was siliconized. A simple assembly table functioned as feed apparatus (11).

A basic sleeve (Blue Light, from Rotec, internal diameter 136.989 mm, external diameter 143.223 mm) was pushed onto the air cylinder of the apparatus described above and was fixed. A 500 μm thick compressible adhesive tape having a shear strength (Rogers SA 2120, shear strength at 70° C.>100 h) was then applied to the basic sleeve without a gap. The compressible layer of the adhesive tape consisted of an open-cell PU foam.

Layer element 1 was exposed to actinic light from the back for 12 seconds through one of the two PET films. Layer element 1 was then cut to size. The two abutting edges were trimmed with an angle of 50° and 55°, relative in each case to the perpendicular, in such a way that the preexposed side of the layer was shorter than the unpreexposed side. The film on the preexposed side was peeled off, including the nontacky release layer, and the layer element was applied with the preexposed side, with constant rotation, to the basic sleeve provided with the adhesive film. After the application of the layer, the second PET film, including the nontacky release layer, was peeled off.

The layer was pressed firmly by means of the auxiliary roll (10). The calender roll was heated to about 130° C., rotated (50 rpm) and brought into contact with the photopolymerizable layer. The distance between the calender roll and the air cylinder was adjusted so that a negative gap of 300 μm resulted (i.e. the calender roll was pressed 300 μm into the elastomeric, photopolymerizable layer). Calendering was effected for 15 minutes for closing the gap. Rotation was effected in direction (7). The surface temperature of the photopolymerizable layer was about 95° C. Thereafter, the rolls were moved apart again and the coated basic sleeve was removed again from the air cylinder after cooling.

A cylindrical, photopolymerizable continuously seamless flexographic printing element was obtained. The surface of the printing element was completely flat in the region of the seam and no traces of the seam at all were detectable. A cut in the region of the seam showed that the seam was not completely closed in the preexposed layer region but the closure in the upper layer region was so good that overall an extremely durable joint was obtained. Stress-strain measurements on the exposed material showed that the samples having a gap and samples comprising the solid surface do not differ substantially with respect to the tensile stress.

### EXAMPLE 2

The procedure was as in example 1, except that layer element 2 was used as starting material. Furthermore, no preexposure was carried out and the calender roll was heated to 135° C. The surface temperature of the flexographic printing element during the calendering was 100° C.

A cylindrical, photopolymerizable continuously seamless flexographic printing element was obtained.

### COMPARATIVE EXAMPLE 1

The procedure was as in example 1, except that the laminate was cut to size not by means of miter cuts but by making two perpendicular cuts. After the sleeve had been wrapped in the photopolymerizable material, a small V-shaped gap remained at the abutment point of the two perpendicular cuts. The gap could be closed by calendering but a small indentation remained at the seam.

### COMPARATIVE EXAMPLE 2

The procedure was as in example 1, except that the calender roll was heated to 150 to 160° C. The surface temperature of the flexographic printing element was about 120° C. Although the seam could be closed, the surface of the photopolymerizable layer was considerably deformed by the excessively high thermal load and had excessively large tolerances after cooling. Regrinding and smoothing were necessary in order to obtain a quality sufficient for flexographic printing. Furthermore, the preexposure through the back lost its effect.

### Comparative Example 3

A layer element was produced by extrusion and calendering using the same components as described in the case of layer element 1. However, only one of the two PET films was peelable while the other PET film was bonded to the photopolymerizable layer by a mixture of adhesion-promoting components. Preexposure was effected through the nonpeelable PET film as described in example 1. After cutting to size as described, the layer element was mounted with the preexposed side and with the nonpeelable film on the basic sleeve and was calendered. Seam closure was obtained but the abutment point of the nonpeelable PET film was still visible as an impression on the layer surface.

### Comparative Example 4

The procedure was as in example 1, except that an adhesive tape having a shear strength of only 2.3 h at 70° C. was used. Although the photopolymerizable layer could be applied without problems, the adhesive tape slipped slightly on the basic sleeve during calendering. The abutment point of the adhesive tape was still clearly visible as an impression in the surface of the photopolymerizable layer.

Further Processing to Give Flexographic Printing Plates

### EXAMPLE 3

An IR-ablative digitally imagable layer comprising carbon black and a binder was applied to the cylindrical, photopolymerizable flexographic printing element according to experiment 1 in a manner known in principle by means of a ring coater as described by DE 299 02 160.

The resulting photosensitive flexographic printing element with the IR-ablative layer was then inscribed imagewise with a continuous pattern by means of an Nd/YAG laser. The pattern was chosen so that printing parts in the region of the seam were also provided.

The sleeve provided with an image was exposed to actinic light in a rotary, cylindrical exposure unit for 20 minutes, then developed with the aid of a flexographic washout agent (nylosolv® II), dried for 2 hours at 40° C. and postexposed for 15 minutes to UV/A and UV/C.

### EXAMPLE 4

The photosensitive flexographic printing element according to experiment 2 was exposed to a mercury halide lamp from Hönle under CO₂ inert gas in an immersion tank lined with aluminum foil, and the photosensitive layer was completely crosslinked.

A printing relief was then engraved into the crosslinked relief layer by means of lasers using a laser system as described by EP-A 1 262 315. A continuous subject was engraved, in such a way that printing parts were also present in each case in the region of the seam.

### COMPARATIVE EXAMPLES 5, 6 AND 7

The procedure was as in example 3, except that in each case the flexographic printing elements according to C1, C3 and C4 were used.

Printing Experiments

Printing experiments were carried out using the cylindrical flexographic printing plates obtained from the experiments and comparative experiments.

Printing press: W&H (Windmöller and Hölscher), printing speed: 150 m/min, print medium: PE film

In the novel examples, a four-color proof showed no gap either in the single color extractions or in the overprinting of all colors, whereas the gap was still visible in the comparative experiments.

The results are summarized in table 1.

TABLE 1
Results of the experiments and comparative experiments

| Flexographic | Produced from | |
|---|---|---|
| printing plate | flexographic printing | |
| No. | element No. | Comment |
| Example 3 | Example 1 | Uniform continuous subject, |
| | | no gap visible in the |
| | | printed image |
| Example 4 | Example 2 | Uniform continuous subject, |
| | | no gap visible in the |
| | | printed image |
| C5 | Example 1 | Gap was visible in the |
| | | printed image |
| C6 | Example 1 | Gap was visible in the |
| | | printed image |
| C7 | Example 1 | Gap was visible in the |
| | | printed image |

Table 1: Results of the experiments and comparative experiments

For checking the printing length, a printing plate having an identical plate on sleeve structure was processed simultaneously with the sleeve according to experiment 3 for the black color and proof printing was effected using the three colors of the continuously seamless sleeves. Result: No deviation of the printing lengths of the individual colors, i.e. the sleeves thus produced experience no change in the circumference during calendering and are compatible with other plate structures.

1. A process for the production of photopolymerizable cylindrical continuously seamless flexographic printing elements by application of a layer of a photopolymerizable material, comprising at least one elastomeric binder, ethylenically unsaturated monomers and a photoinitiator, to the outer surface of a hollow cylinder and joining of the layer ends by calendering, wherein the process comprises the following steps:
(a) providing a laminate of a photopolymerizable material a substrate film which can be peeled off from the layer, and optionally a further peelable film on that side of the layer which faces away from the substrate film,
(b) cutting the edges of the laminate to be joined to size by means of bevel cuts,
(c) pushing the hollow cylinder onto a rotatably mounted support cylinder and locking it thereon,
(d) applying an adhesion-promoting layer to the outer surface of the hollow cylinder,
(e) applying the laminate, if applicable, after peeling off the further peelable film, cut to size, on the side of the photopolymerizable layer facing away from the temporary substrate film, to the hollow cylinder provided with the adhesion-promoting layer, the ends provided with the bevel cut substantially resting against one another but not overlapping,
(f) peeling off the substrate film from the layer of photopolymerizable material,
(g) joining the cut edges at a temperature below the melting point of the photopolymerizable layer by bringing the surface of the photopolymerizable layer on the hollow cylinder into contact with a rotating calender roll until the cut edges are joined to one another,
(h) removing the processed hollow cylinder from the support cylinder.

2. A process as claimed in claim 1, wherein the adhesion-promoting layer is a double-sided adhesive film.

3. A process as claimed in claim 2, wherein the adhesion film has a static shear strength, measured according to DIN EN 1943, of at least 3 h at 70° C.

4. A process as claimed in claim 1, wherein the layer of photopolymerizable material comprises a further peelable film on that side of the layer which faces away from the substrate film, which peelable film is peeled off before process step (e).

5. A process as claimed in claim 1, wherein, before process step (e), the layer of photopolymerizable material is preexposed to actinic light, directly or through the further peelable film, from the side facing away from the substrate film.

6. A process as claimed in claim 5, wherein the preexposure is effected before process step (b).

7. A process as claimed in claim 1, wherein the coated hollow cylinder rotates in the direction (7) during calendering.

8. A process as claimed in claim 1, wherein the temperature of the plate surface during calendering is from 80 to 130° C.

9. A process as claimed in claim 1, wherein the support cylinder is an air cylinder.

10. A process as claimed in claim 1, wherein, in a further process step (i), a digitally imagable layer is applied to the photopolymerizable layer.

11. A process as claimed in claim 10, wherein the digitally imagable layer is one selected from the group consisting of IR-ablative layers, inkjet layers and thermographically recordable layers.

12. A cylindrical, continuously seamless, photopolymerizable flexographic printing element obtainable by the process of claim 1.

13. A cylindrical, continuously seamless, photopolymerizable flexographic printing element having a digitally imagable layer and obtainable by the process of claim 10.

14. The use of a digitally imagable cylindrical flexographic printing element as claimed in claim 13 for the production of cylindrical, continuously seamless flexographic printing plates, wherein the digitally imagable layer is recorded on imagewise, the photopolymerizable layer is exposed to actinic light through the mask formed and unexposed parts of the layer are removed in a development step.

15. The use as claimed in claim 14, wherein the development of the exposed layer is carried out by means of a solvent or solvent mixture.

16. The use as claimed in claim 14, wherein the development of the exposed layer is carried out thermally.

17. The use of a cylindrical flexographic printing element as claimed in claim 12 for the production of cylindrical, continuously seamless flexographic printing plates, wherein the photopolymerizable layer is completely crosslinked with actinic light and a printing relief is then engraved into the polymerized layer by means of one or more lasers.

18. The use as claimed in claim 17, wherein the laser or lasers has or have a wavelength from 9 000 to 12 000 nm.
